(19) United States
(12) Patent Application Publication
(10) Pub. No.: US 2026/0003679 A1
(43) Pub. Date: Jan. 1, 2026

(54) SYSTEM AND METHOD FOR EXECUTING FUSED NEURAL-NETWORK LAYER ARCHITECTURES

(71) Applicant: Bayris Inc., Mountain View, CA (US)

(72) Inventor: Jorge Campos, Mountain View, CA (US)

(73) Assignee: Bayris Inc., Mountain View, CA (US)

(21) Appl. No.: 18/759,762

(22) Filed: Jun. 28, 2024

(51) Int. Cl. G06F 9/50; G06F 9/54

(52) U.S. Cl. CPC G06F 9/5016; G06F 9/544

(57) ABSTRACT

The present disclosure provides a system and method for executing fused neural network layers using a graphics processing unit (GPU). The fused neural network layer combines multiple neural network operations into a single GPU kernel function, for efficient utilization of a GPU shared memory to reduce global memory transactions. The fused neural-network-layer system configures GPU thread blocks to iterate tiles in the GPU shared memory across portions of input tensors, and to perform a sequence of neural network layer operations using the tiles, before storing the results in an output tensor. The neural network layer operations can include element-wise, normalization, and pooling operations. The system also supports fused layers with nested traversals of input tensors, such as matrix multiplication, convolution, and attention mechanisms. The fused neural-network-layer system improves performance and reduces memory overhead compared to executing each layer as a separate GPU kernel, thereby enabling faster training and inference times.

### TECHNICAL FIELD

The present disclosure generally relates to executing artificial neural networks on graphics processing units (GPUs). More specifically, the present disclosure relates to executing an artificial neural network on a GPU by fusing multiple neural network layers into a single fused layer to be executing within a single GPU kernel.

### BACKGROUND

Artificial neural networks are a class of machine learning models that are widely used for tasks such as image recognition, natural language processing, and prediction. These models are typically composed of multiple layers of interconnected nodes or “neurons” that process input data and generate outputs. During the training process, the neural network learns to map inputs to desired outputs by adjusting the strength of the connections between neurons.

However, training this neural network's model weights, and performing inferences based on this neural network, is a computationally expensive process that is oftentimes accelerated by graphics processing units (GPUs). GPUs are highly parallel processors that can greatly accelerate neural network computations. For example, GPU-accelerated neural networks are oftentimes implemented using a sequence of distinct layers, wherein each layer can be implemented by configuring a host computer to launch a separate GPU kernel to perform a specific computation on the data flowing through the network. The outputs of one layer are oftentimes stored in the GPU's global memory, so that they may be accessed as inputs to the next layer in the sequence of layers. However, this sequential layer-based approach limits the ability to apply certain GPU optimizations to the code that runs within each GPU kernel.

FIG. 1 illustrates a typical neural network deployment on a GPU device 110 (or simply “GPU 110”). A neural network model 113 (or simply “neural network 113”) can reside in a global memory 112 of GPU 110, and can include a sequence of layers 116, 120, and, 124 that a host CPU 106 of the host computer system 102 can launch as separate GPU kernels. A launched GPU kernel for layer 116 can process an input tensor 114 to generate and store an intermediate tensor 118 onto GPU global memory 112. GPU 110 may then run a separate GPU kernel that executes layer 120 that processes intermediate tensor 118 to update the contents of another intermediate tensor 122, which is also stored in GPU global memory 112. GPU 110 may launch another GPU kernel to process a final layer 124 that updates an output tensor 126 as the final output for neural network 113, which is also stored in GPU global memory 112.

In the above-described conventional approach, each layer 116, 120, or 124 is computed by a separate GPU kernel launched by a host program 108 of the host computer system 102 running on the CPU 106. The intermediate outputs (e.g., tensors 118 and 122) are stored in the GPU's global memory 112. GPU global memory 112 is the largest memory in GPU 110, which can facilitate running large neural networks, such as large language models with many billions of parameters. Unfortunately, GPU global memory 112 is also the slowest memory in GPU 110. As such, writing and reading tensors to and from GPU global memory 112 can be a significant performance bottleneck. Hence, what is needed is an improved neural network architecture that can reduce the performance bottlenecks caused by these global memory transactions.

### SUMMARY

The present disclosure provides a system and method for executing fused neural network layers using a graphics processing unit (GPU). The fused neural network layer combines multiple neural network operations into a single GPU kernel function, for efficient utilization of a GPU shared memory to reduce global memory transactions. The fused neural-network-layer system configures GPU thread blocks to iterate tiles in the GPU shared memory across portions of input tensors, and to perform a sequence of neural network layer operations using the tiles, before storing the results in an output tensor. The neural network layer operations can include element-wise, normalization, and pooling operations. The system also supports fused layers with nested traversals of input tensors, such as matrix multiplication, convolution, and attention mechanisms. The fused neural-network-layer system improves performance and reduces memory overhead compared to executing each layer as a separate GPU kernel, thereby enabling faster training and inference times.

In one aspect, a process for executing, by a graphics processing unit (GPU), a fused neural network layer that implements a sequence of neural network layer operations is disclosed. The process may begin by loading a first tile of a first input tensor of the fused neural network layer, from a first global-memory array allocated for the first input tensor in a global memory of the GPU, into a first shared-memory array allocated for the first tile in a shared memory of the GPU, wherein the first tile comprises a partition of the first input tensor of a first size and shape for processing the fused neural network layer during a first tile-processing iteration. Next, the process performs, using the GPU, a first neural network layer operation of the sequence of neural network layer operations, wherein the first neural network layer operation includes: (1) reading a first value from a first cell of the first tile; (2) generating a second value using a computation from the first neural network layer operation that operates at least on the first value; and (3) updating a second cell of a second shared-memory array allocated for a second tile in the shared memory of the GPU, to store the second value into the second tile, thereby storing intermediate values of the fused neural network layer into a portion of the shared memory of the GPU instead of writing the intermediate values into a portion of the global memory of the GPU. Next, the process performs, using the GPU, at least one additional neural network layer operation of the sequence of neural network layer operations, wherein the at least one additional neural network layer operation includes: (1) generating a third value using computations from the at least one additional neural network layer operation, which operate at least on the second value in the second tile; and (2) updating a third cell of a third shared-memory array in the shared memory of the GPU to store the third value. Subsequently, the process stores the third cell to an output tensor of the fused neural network layer in the global memory of the GPU.

In some embodiments, the process performs a respective neural network layer operation of the fused neural network layer by calling a function that corresponds to the respective neural network layer operation, wherein the function takes at least the first tile or the second tile as function arguments.

In some embodiments, the process performs the first neural network layer operation by iterating a third tile across one or more portions of a second input tensor in the global memory of the GPU, for a respective iteration of the first tile across the first input tensor. More specifically, during a respective iteration of the third tile, the process further includes the steps of: (1) loading the third tile from a portion of the second input tensor that corresponds to the tile iteration of the third tile; (2) generating the second value by performing the first neural network layer operation, which requires two nested traversals of the first and second input tensors using the first tile and the third tile; and (3) updating the second cell by accumulating the second value into the second cell using an operation selected from the group consisting of addition, maximum comparison, and minimum comparison.

In some embodiments, the two or more neural network layer operations that require two nested traversals of the input tensors are selected from the group that includes: (1) matrix multiplication operation; (2) a convolution operation; (3) a cross-correlation operation; (4) an attention mechanism; (5) an outer product operation; (6) a tensor contraction operation; (7) a distance computation between pairs of elements from the first input tensor and the second input tensor; and (8) a similarity computation between pairs of elements from the first input tensor and the second input tensor.

In some embodiments, a respective neural network layer operation is selected from the group that includes: (1) an element-wise layer operation; (2) a normalization layer operation; and (3) a pooling layer operation.

In some embodiments, the element-wise layer operation is selected from the group that includes: (1) an activation function; (2) an element-wise arithmetic operation; (3) a dropout operation; and (4) a bias-addition operation.

In some embodiments, the normalization layer operation is selected from the group that includes: (1) a batch normalization operation; (2) a layer normalization operation; and (3) an instance normalization operation.

In some embodiments, the pooling layer operation is selected from the group that includes: (1) a max pooling operation; (2) a min pooling operation; and (3) an average pooling operation.

In some embodiments, each of the first tile and the second tile includes: (1) metadata comprising shape information that indicates a length for a respective dimension of the associated tile; and (2) one or more cells for storing numeric values across one or more dimensions of the associated tile.

In some embodiments, the sequence of neural network layer operations of the fused neural network layer operate one or more tiles in the shared memory of the GPU, without invoking additional read or write operations to a global-memory array in a global memory region of the GPU.

In some embodiments, the sequence of neural network layer operations of the fused neural network layer is executed by the GPU using a single GPU kernel.

In another aspect, a graphics processing unit (GPU) for executing a fused neural network layer that implements a sequence of neural network layer operations is disclosed. This GPU can include a global memory, a set of multiprocessor blocks coupled to the global memory, and a shared memory coupled to a respective multiprocessor block in the set of multiprocessor blocks. At runtime, the GPU may dispatch one or more thread blocks per multiprocessor block. The shared memory is configured to load a first tile of a first input tensor of the fused neural network layer, from a first global-memory array allocated for the first input tensor in the global memory, into a first shared-memory array allocated for the first tile in the shared memory, wherein the first tile comprises a partition of the first input tensor of a first size and shape for processing the fused neural network layer during a first tile-processing iteration. The respective thread block is configured to perform a first neural network layer operation of the sequence of neural network layer operations, wherein the first neural network layer operation includes: (1) reading a first value from a first cell of the first tile; (2) generating a second value using a computation from the first neural network layer operation that operates at least on the first value; and (3) updating a second cell of a second shared-memory array allocated for a second tile in the shared memory, to store the second value into the second tile, thereby storing intermediate values of the fused neural network layer into a portion of the shared memory instead of writing the intermediate values into a portion of the global memory. The respective thread block is further configured to perform at least one additional neural network layer operation of the sequence of neural network layer operations, wherein the at least one additional neural network layer operation includes: (1) generating a third value using computations from the at least one additional neural network layer operation, which operate at least on the second value in the second tile; (2) updating a third cell of a third shared-memory array in the shared memory to store the third value; and (3) storing the third cell to an output tensor of the fused neural network layer in the global memory.

### BRIEF DESCRIPTION OF THE DRAWINGS

The structure and operation of the present disclosure will be understood from a review of the following detailed description and the accompanying drawings in which like reference numerals refer to like parts and in which:

FIG. 1 illustrates a typical neural network deployment on a GPU device.

FIG. 2 illustrates a block diagram of a fused layer system in accordance with some embodiments described herein.

FIG. 3 illustrates a detailed view of a Layer Tile data structure which can be used to organize information within the shared memory of the fused layer system of FIG. 2 in accordance to some embodiments described herein.

FIG. 4 illustrates a process for executing a fused neural network layer in accordance with some embodiments described herein.

FIG. 5 illustrates a block diagram of a fused neural network layer system and architecture including multiple input tiles in accordance with some embodiments described herein.

FIG. 6 illustrates a process for executing a fused neural network layer including nested tile-processing iterations in accordance with some embodiments described herein.

FIG. 7 illustrates a block diagram of a fused neural network layer system that uses tiling to perform computations involving two nested loop iterations in accordance with some embodiments described herein.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

### Overview

The present disclosure provides a fused neural network layer system that can optimize the performance and resource utilization of a neural network deployed on a graphics processing unit (GPU) or similar parallel processing hardware. The disclosed fused neural network layer system can combine, or “fuse,” multiple neural network layers or computation stages into a single GPU kernel, thereby reducing processing overhead due to multiple kernel invocations and the associated data movements both to and from a GPU's global memory.

Moreover, a shared memory of the GPU is not guaranteed to hold its values across multiple GPU kernel invocations. Hence, using the disclosed fused neural network layer system to implement a neural network architecture in a single GPU kernel has another significant benefit: it allows an advanced numerical program to implement a “fused” solution, that leverages the shared memory of the GPU across multiple computation steps that would have otherwise been implemented in separate GPU kernels.

Hereinafter, the term “fused layer system” and the term “fused system” may be used interchangeably to refer to the disclosed fused neural network layer system. In some embodiments, the fused layer system can include a computer system (e.g., a server or desktop computer, or a mobile computing device) that further includes one or more GPUs, wherein each respective GPU of the one or more GPUs is configured to run a neural network comprising at least one fused layer. The term “fused neural network layer” or “fused layer” is hereinafter used to describe a portion of a program (e.g., a function or a block of code) within a GPU kernel of the fused layer system, where this program includes two or more neural network layers that together process one or more input tensors to update values onto at least one output tensor.

In some embodiments, the GPU may be a general-purpose GPU (GPGPU) processor, a stream processor (SP), or a shared-memory multiprocessor (SMP). Alternatively, the GPU may be an integrated graphics processing unit (IGPU) or a hybrid GPU, which can make use of the host computer system's random-access memory (RAM) for at least a portion of the GPU's global memory layer. Hereinafter, the term “GPU” may refer to any numerical accelerator such as a GPU, a GPGPU, a stream processor (SP) or shared-memory multiprocessor (SMP) that includes dedicated on-board global memory, an IGPU that uses the host computer's RAM as the IGPU's global memory layer, and/or any SP, SMP, GPGPU, GPU, or hybrid GPU that includes dedicated global memory and may also utilize RAM as extended global memory. The GPU can include a global memory, a set of multiprocessor blocks coupled to the global memory, and a shared memory coupled to a respective multiprocessor block in the set of multiprocessor blocks. At runtime, the GPU may dispatch one or more thread blocks per multiprocessor block. The disclosed fused layer system can improve the performance of a neural network execution whose control flow is managed from within a kernel function running on the GPU, for example, by using the GPU shared memory to hold numerical data used by a sequence of neural network layers.

The disclosed fused layer system can also include a neural network comprising a combination of fused neural network layers and non-fused (e.g., a single elementary neural network layer, which can include but not limited to: a convolution layer, a matrix multiplication layer, a normalization layer, a pooling layer, an element-wise operation layer, and any other numerical operation layer now known or later developed, hereinafter a single elementary neural network layer is also referred to as “elementary layer” or “single layer”) components that a computer system may run through one or more GPU kernels. Hereinafter, a fused neural network layer is simply referred to as a “fused layer.” Similar to a single layer component, a fused layer may take one or more tensors in a GPU global memory as input, and may store a result (i.e., an output of the fused layer) to another tensor in the GPU global memory. One main distinction between a single layer and a fused layer, however, is that a fused layer can combine and implement multiple elementary neural network layers internally. Hence, a single elementary layer within a fused layer is hereinafter referred to as an “internal layer.”

In some embodiments, an entire neural network may run inside a single GPU kernel, wherein the neural network can comprise multiple fused layers as well as multiple non-fused, single layer components. Also note that the fused layer may utilize one or more “tile” data structures residing in a shared memory of the GPU (or “GPU shared memory”) to store intermediate results generated between two consecutive internal layers within the fused layer, instead of storing the intermediate results in a tensor residing in the GPU global memory. A “tile” generally refers to a single partition of a tensor or an array, after the tensor or array is partitioned a number of times along each of its dimensions. Hereinafter, the term “tile,” “shared-memory tile,” or “Layer Tile” may be used interchangeably to refer to a multi-dimensional partition of an array (with one or more dimensions) in the GPU shared memory, wherein this region of space can be used by the fused layer system to store a partition of a tensor that resides in the GPU global memory, or to store an intermediate tile that would otherwise have been stored in the GPU global memory.

In some embodiments, a GPU shared memory can be orders of magnitude faster than a GPU global memory, thereby allowing for much faster propagation of data through the network. Additionally, implementing multiple neural network layers inside a single GPU kernel can eliminate the need to launch a separate GPU kernel per layer, thereby reducing the overhead associated with switching among multiple GPU kernels.

The disclosed fused layer system can leverage several advantageous features of modern GPU hardware (listed below) to achieve high performance:
1. Thread parallelism: a typical GPU can contain thousands of parallel threads. The disclosed fused layer system can partition these parallel threads into one or more GPU thread blocks. As such, the fused layer system can organize the data processing between internal layers of a fused layer at a thread block level, to compute neural network operations in a highly parallel manner. For example, the fused layer system can configure a thread block to operate on a unique portion of the fused layer's input tensor and/or output tensor, across multiple internal neural network layers, without encountering a full-GPU-level synchronization barrier among these internal layer operations within the fused layer.
2. Shared memory: a GPU shared memory within a GPU is a fast, on-chip, L1 memory that is shared among threads within a thread block. The fused layer system can allow an internal layer within a fused layer to store its intermediate results in the GPU shared memory for the next internal layer to use, thereby minimizing accesses to slower global memory on the same GPU.
3. Memory coalescing: a GPU's memory transaction is oftentimes performed by 32 threads in parallel (a group of 32 threads is hereinafter referred to as a “warp”). A GPU global memory is most efficiently accessed when threads in a warp read or write contiguous memory locations in one memory transaction. The disclosed fused layer architecture is designed to promote coalesced memory accesses when reading from an input tensor, or writing to an output tensor, which can help to maximize memory bandwidth utilization.
4. Reduced kernel launches: launching a GPU kernel incurs overhead as control is passed from the host computer system to the GPU. The fused layer system combines multiple basic neural network layers into a single fused layer, and can run one or more of these fused layers in a GPU kernel so that this kernel overhead is incurred only once per group of fused layers, instead of once per basic neural network layer.

The disclosed fused neural network layer system is configured with a flexible architecture that can be applied to various types of neural networks, including but not limited to, feed-forward, convolutional, and recurrent networks. The architecture of the fused layer system is also configured to support existing neural network operations such as matrix multiplication, convolution, activation functions, and normalization, among others.

In some embodiments, the fused layer system can use memory tiling to efficiently process a large input or output tensor that may not fit entirely into a GPU shared memory. Specifically, the fused layer system can “tile” through a tensor by dividing the tensor into smaller sub-tensors, or “tiles,” wherein each of these sub-tensors/tiles is small enough to fit into a tile within a GPU shared memory. One or more individual thread blocks of the fused layer can iterate over these sub-tensors to compute a set of partial results, and can accumulate the set of partial results into an output tile in their shared memory, before writing or accumulating the contents of their output tile back to a corresponding region of the GPU global memory (e.g., a portion of an output tensor).

Overall, the fused neural network layer system provides a high-performance solution for deploying a multi-layer neural network on a GPU, thereby enabling a faster training and inference runtime by making more efficient use of the GPU's resources. The following sections describe the architecture of the fused layer system in more detail, including the GPU memory hierarchy, fused layer computation flow, and various tile-based processing techniques.

### Fused Neural Network Layer

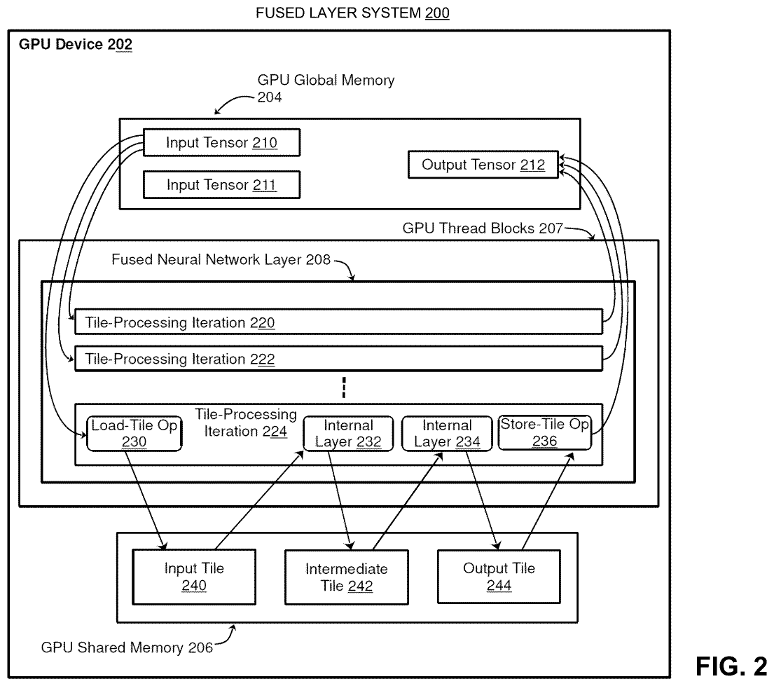

FIG. 2 illustrates a block diagram of a fused layer system 200 in accordance with some embodiments described herein. Fused layer system 200 can include a GPU device 202 that further comprises a GPU global memory 204 (or “global memory 204”), a GPU shared memory 206 (or “shared memory 206”), and a set of GPU thread blocks 207. Global memory 204 can store at least an input tensor 210 and an output tensor 212, which represent the input data and output data associated with a fused neural network layer 208, respectively. GPU thread blocks 207 can include one or more thread blocks, wherein a respective thread block can include a dedicated region of shared memory 206 that is not accessible by other thread blocks of GPU thread blocks 207, and the respective thread block can further include one or more threads that execute on GPU processing cores and have access to the same shared memory region.

Fused layer 208 can be deployed within a single GPU kernel that runs on GPU device 202, either alone or in combination with one or more other elementary layers and/or other fused layers of the same neural network architecture. Fused layer 208 can include multiple internal layers 232-236 corresponding to elementary layer operations that may be computed in sequence within the same GPU kernel. These elementary layer operations may include, but are not limited to, a matrix multiplication layer, a convolution layer, an element-wise operation layer, a normalization layer, and a pooling layer. The element-wise layer, for example, can include, but is not limited to: an activation function; an element-wise arithmetic operation; a dropout operation; and a bias addition operation. The normalization layer can include, but is not limited to, a batch normalization operation, a layer normalization operation, and an instance normalization operation. Moreover, the pooling layer can include, but is not limited to, a max pooling operation, a min pooling operation, and an average pooling operation.

In some embodiments, fused layer 208 can configure the shape (e.g., a size of each dimension) of a tile within shared memory 206 to maximize utilization of the shared memory 206 while still allowing for efficient parallel processing by multiple threads. Fused layer 208 can then pass the shape of the tile to its internal layers along with the tile, wherein the shape information of the tile controls how an internal layer uses the threads of a GPU thread block to process the tile. Note that a sub-optimal tile shape that allocates too few cells for the higher dimension(s) of the tile can cause an internal operation of the fused layer to utilize a subset of threads within a warp, whereas a tile shape that allocates too few rows in a tile can cause the internal operation to utilize too few warps to iterate across the tile. Hence, a balance between sizes for the lower and higher dimensions can achieve an optimal thread utilization within a GPU thread block.

For example, if the cells of a tile are organized in a row-major format, fused layer 208 may select the size of one or more higher dimensions sufficiently large so that they may be operated on by a GPU warp (e.g., 32 cells, but can be lower if the tensor's higher dimensions are small). This configuration can leave sufficient tile cells for the lower dimensions (e.g., tile rows) so that the set of warps in the GPU thread block can be utilized to process the tile. Moreover, this configuration can facilitate an internal layer operation to distribute its assigned GPU warps across tensor batches, tensor channels, and/or lower dimensions of the input data.

Fused layer 208 may also allocate additional tiles in shared memory 206, such as an intermediate tile 242 and an output tile 244. Fused layer 208 may then perform a plurality of internal layer operations (e.g., internal layers 232-236) on tiles 240-244 in shared memory 206. For example, internal layer 232 may be implemented as a function that can take at least tiles 240 and 242 as input arguments, may process the data within at least input tile 240, and store computation results onto intermediate tile 242. Similarly, internal layer 234 may be implemented as another function that can take at least tiles 242-244 as input arguments, may process data within at least intermediate tile 242, and store its computation results onto output tile 244. By keeping intermediate results in shared memory 206, fused layer 208 can avoid the need to write these results back to global memory 204, which would incur significant performance overheads.

During execution, a load-tile operation 230 of fused layer 208 can load input data from input tensor 210 in global memory 204 into an input tile 240 in shared memory 206. Load-tile operation 230 can store into input tile 240, a portion of input tensor 210 that fits within a memory portion of shared memory 206 that has been allocated for input tile 240.

In some embodiments, fused layer 208 may distribute partitions from input tensor 210 and/or output tensor 212 into one or more tile-processing iterations 220-224, which fused layer 208 may distribute onto a plurality of GPU thread blocks. Hence, operations 230-236 may operate local to a tile-processing iteration (e.g., each of tile-processing iterations 220-224), which may run in parallel with the other tile-processing iterations running on other GPU thread blocks. Moreover, tile-processing iterations 220-224 may each be processed by a different thread-block iteration which utilizes a local shared memory region that typically runs faster and with less latency than GPU global memory 204.

This configuration can allow multiple tile-processing iterations to concurrently load their corresponding portion of input tensor 210 (in global memory 204) into their input tile 240 (in shared memory 206), and/or to concurrently store the contents of their output tile 244 (in shared memory 206) into their corresponding portion of output tensor 212 in global memory 204.

After fused layer 208 has processed neural network operations 232-236, the final output of fused layer 208 may reside in output tile 244, which itself resides in shared memory 206. Output tile 244 represents a portion of output tensor 212, and corresponds to the data processed based on input tile 240. Hence, fused layer 208 may finalize its operation sequence by running at least a store tile operation 236, which copies the contents of output tile 244 into its corresponding portion of output tensor 212. The contents of output tensor 212 generated by fused layer 208 can then be accessed by other fused neural network layers, other GPU kernels, and/or processes running on the host computer.

By fusing multiple neural network layers/operations into a single GPU kernel and leveraging shared memory to store intermediate results, fused layer system 200 can significantly reduce the overheads associated with launching multiple GPU kernels, and associated with accessing data from intermediate tensors in global memory 204. This overhead reduction results in improved performance and efficiency when compared to neural network implementations that run a separate GPU kernel per neural network layer. This performance improvement can further lead to faster model training and inference times, as well as more efficient utilization of GPU memory and processing resources.

In some embodiments, a variation of fused layer system 200 can include one or more additional tiles, and a respective tile-processing iteration within the set of tile-processing iterations may include one or more additional load-tile operations, internal layers, and/or store-tile operations. In some further variations, fused layer system 200 may include nested loops to implement a Cartesian-product traversal of multiple input tensors, such as by including one or more inner-loop tile-processing iterations within tile-processing iteration 224, wherein a nested tile-processing iteration may itself include one or more load-tile operations, internal layers, and/or store-tile operations. Note that the operations performed within the fused neural network layer may vary depending on the type and structure of the neural network being implemented. The fused neural network layer system 200 provides a flexibility that can accommodate a wide range of neural network designs and use cases.

Furthermore, fused neural network layer system 200 can include a combination of multiple fused layers and/or one or more original non-fused layers of a neural network, wherein a respective fused layer in the multiple layers can process the output tensor of its previous layer, and/or populating a tensor that is processed by its next layer. This configuration can enable fused layer system 200 to implement deep, multi-layered neural networks that benefit from the performance optimizations provided by a plurality of fused layers and basic layers.

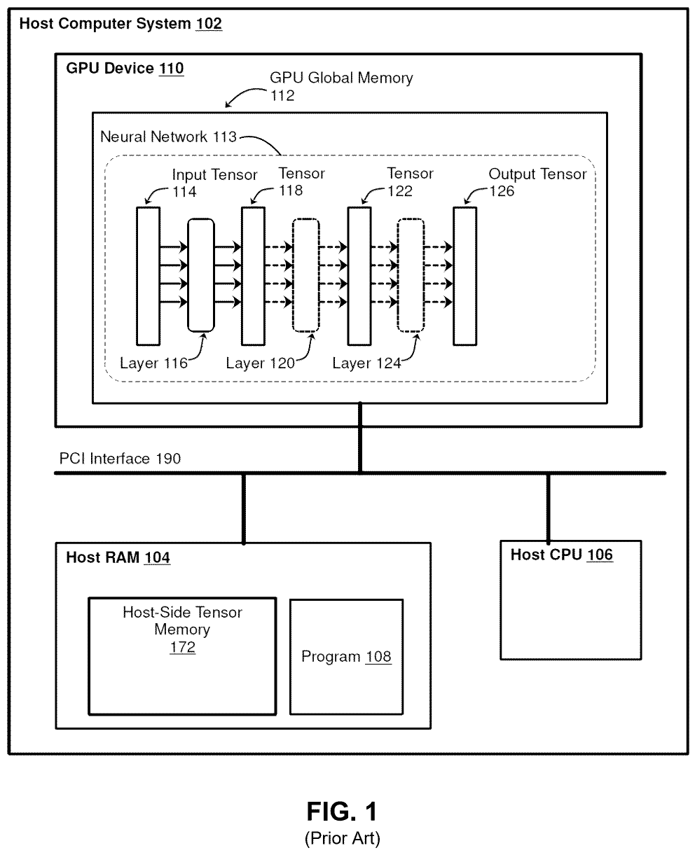

To further illustrate how fused layer system 200 can be used to implement a neural network architecture, let's consider neural network 113 illustrated in FIG. 1. Fused layer system 200 can be used to implement neural network 113, for example, by configuring GPU thread blocks 207 to load portions of input tensor 114 from GPU global memory 204 into a tile in GPU shared memory 206. Fused layer system 200 may then configure a respective GPU thread block within GPU thread blocks 207 to implement layers 116, 120, and 124 as internal layers that operate on shared-memory tiles, without requiring layers 116, 120, and 124 to directly access tensors 114, 118, 122, and 126 from GPU global memory 204.

In some embodiments, fused layer system 200 may implement these internal layers within neural network 113 as functions or code blocks that execute within one GPU Kernel, instead of running as individual kernels themselves. For example, an internal layer that corresponds to layer 116 may operate on a shared-memory tile that corresponds to input tensor 114 and intermediate tensor 118. An internal layer that corresponds to layer 120 may operate on shared-memory tiles that correspond to intermediate tensors 118 and 122. Then, an internal layer that corresponds to layer 124 may operate on a shared-memory tile that corresponds to intermediate tensor 122 and an output shared-memory tile that corresponds to output tensor 126. Each thread block may then store or accumulate their output shared-memory tile onto output tensor 126 before initiating another tile-processing iteration.

### Layer Tile

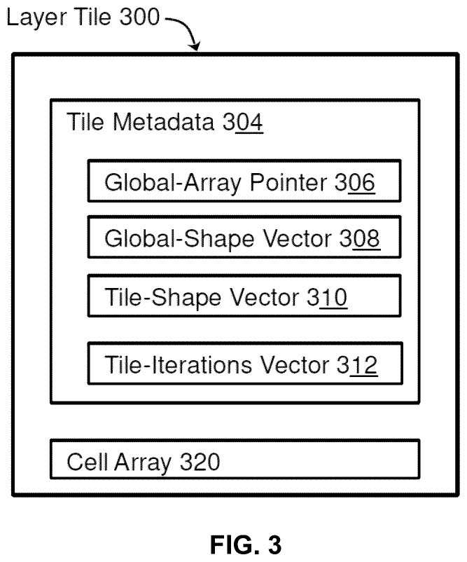

FIG. 3 illustrates a detailed view of a Layer Tile data structure 300 (or simply “Layer Tile 300” hereinafter) which can be used to organize information within shared memory 206 in fused layer system 200 of FIG. 2 in accordance to some embodiments described herein. Generally, Layer Tile 300 may implement a data structure that can be used to store and manipulate input data, intermediate results, and output data associated with a tile-processing iteration of a fused neural network layer in layer system 200.

As illustrated in FIG. 3, Layer Tile 300 may include a tile metadata 304 and a cells array 320 for a corresponding tile. Cells array 320 can hold the tile's data values, while tile metadata 304 can contain a set of settings that describe: (1) a structure and layout of the associated tile in GPU shared memory 206; (2) a pointer to a tensor that the tile corresponds to; and (3) tile-processing iteration data. A fused layer can be configured to initialize vectors 308-312 in metadata 304, which in turn configures how a tile-storing operation or a tile-loading operation uses the threads of a GPU thread block to perform coalesced memory access operations to or from a tensor in GPU global memory. The settings in tile metadata 304 can also be used to configure how an internal layer uses the threads of a GPU thread block to process the data values in cells array 320 of Layer Tile 300, such as when performing a matrix-multiplication operation between two tiles in GPU shared memory 206.

In some embodiments, the set of settings in tile metadata 310 can include:
1. a global-array pointer 306: this is a pointer to the corresponding tensor in GPU global memory 204 that Layer Tile 300 is associated with. Fused layer 208 can set global array pointer 306 to preserve register memory, and to simplify loading a portion of the corresponding tensor onto Layer Tile 300;
2. a global-shape vector 308: this vector includes an array of integers that specifies the size for each dimension of the global tensor that Layer Tile 300 is associated with. The vector can be used to compute the mapping between tile indices and global tensor indices;
3. a tile-shape vector 310: this vector includes an array of integers that can specify the sizes for various dimensions of cells array 320, which indicate a size and shape of the tile; and
4. a tile-iterations vector 312: this vector includes an array of integers that can specify a number of tiles required to cover each dimension of the tensor in GPU global memory 204. Fused layer 208 can use tile-iterations vector 312 to compute a total number of tiles that need to be processed, and to compute memory locations of the tensor in GPU global memory 204 for a respective tile-processing iteration.

Cells array 320 can include a contiguous block of shared memory that can hold the data values of Layer Tile 300. The size of the cells array 320 can be greater than or equal to a size indicated by tile-shape vector 314. Cells array 320 can be accessed using indices that correspond to the tile dimensions specified by tile-shape vector 310 of Layer Tile 300.

In some embodiments, the fused layer system 200 can use memory coalescing techniques to efficiently populate cells array 320 of Layer Tile 300, using data from the corresponding tensor in GPU global memory 204. For example, one or more GPU warps can independently iterate across regions of the corresponding tensor, wherein the threads in each warp can access contiguous elements of the global tensor's memory region. These warp threads may then store these elements in contiguous locations in the cells array 320, which resides in GPU shared memory. This ensures that the global memory accesses are coalesced, thereby maximizing memory bandwidth utilization.

Similarly, when storing intermediate-layer results from Layer Tile 300 back to their corresponding cells in global memory 204, fused layer system 200 can configure the threads in the corresponding warp to write contiguous elements from cells array 320 to their corresponding contiguous locations in the region of global memory 204 that stores the tensor. Again, this ensures that the global memory accesses are coalesced for optimal performance.

### Fused Neural Network Layer Architectures

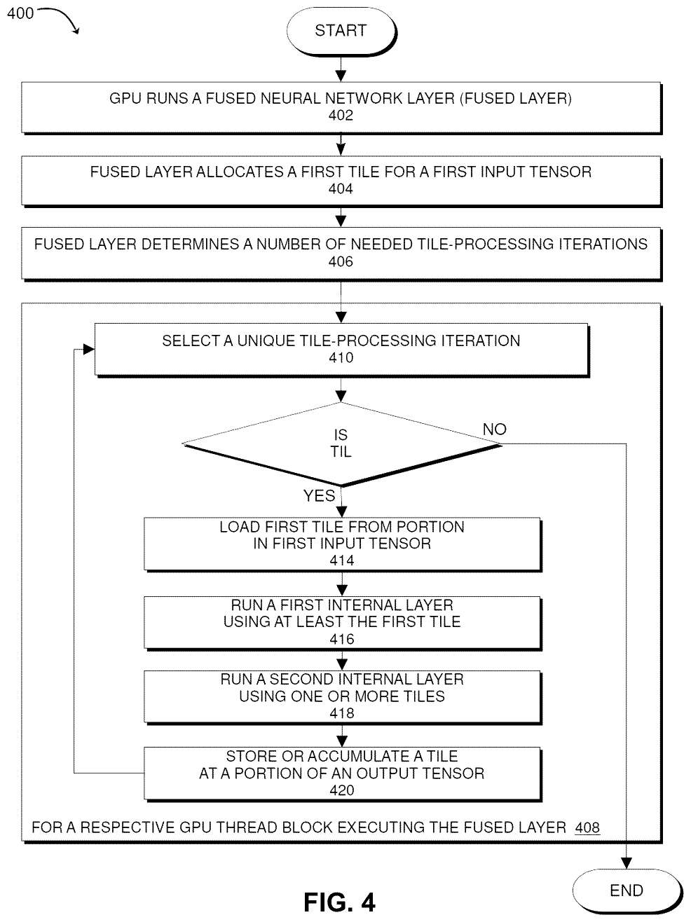

FIG. 4 illustrates a process 400 for executing a fused neural network layer in accordance with some embodiments described herein. Process 400 may begin with a GPU running a fused neural network layer (e.g., fused layer 208 in FIG. 2) (step 402). The fused layer can combine multiple internal layer operations, such as a convolution, an activation, and/or a normalization operation, into a combined computation step, wherein the combined computation step can then be executed within a single GPU kernel. By fusing these internal layer operations together, the fused layer can reduce overhead due to global memory access, and can improve performance compared to executing each internal layer as a separate GPU kernel.

The fused layer may allocate at least a first tile within the GPU shared memory for a first input tensor (step 404). In some embodiments, the fused layer system 200 may select the size of the tile to maximize the utilization of the shared memory, while ensuring that each thread block can allocate the one or more tiles that are needed by the fused layer to perform the associated computations efficiently.

Next, the fused layer can determine the number of tile-processing iterations needed to traverse the first input tensor across its dimensions (step 406). In some embodiments, the number of tile-processing iterations is calculated based on the size of the input tensor, and the size of the allocated tile. For example, if the input tensor has dimensions {512, 256, 32} and the tile size has dimensions {8, 16, 32}, then the number of required tile-processing iterations would be {64, 16, 1}. In some alternative embodiments, such as when aggregating values onto a target tensor, the number of tile-processing iterations may be calculated based on the size of the output tensor.

After determining the number of tile-processing iterations, the fused layer can configure the set of GPU thread blocks to collectively perform the tile-processing iterations. More specifically, a respective GPU thread block in the set of GPU thread blocks can perform a sequence of steps 410-420 for at least a subset of the tile-processing iterations, in parallel to the tile-processing iterations performed by the other GPU thread blocks (step 408). For the respective GPU thread block executing the fused layer, the respective GPU thread block can select a unique tile-processing iteration that no other thread block will select (step 410). This can be achieved by configuring the respective thread block to stride across the total number of tile-processing iterations by the number of available blocks, with individual thread blocks starting at their unique block identifiers. For instance, if there are 256 tile-processing iterations and 64 thread blocks, the respective thread block can execute 4 tile-processing iterations selected based on its unique block ID (e.g., GPU thread block 0 can execute iterations 0, 64, 128, and 192; GPU thread block 1 can execute iterations 1, 65, 129, and 193; GPU thread block 2 can execute iterations 2, 66, 130, and 194, etc.).

The GPU thread block may then determine whether the selected tile-processing iteration is within the valid range of iterations (step 412). If not, the GPU thread block can exit the loop, or alternatively wait for the other thread blocks to complete their iterations. Otherwise, the GPU thread block can proceed from step 412 to load the first tile from the portion of the first input tensor corresponding to its current tile-processing iteration (step 414).

After the tile data have been loaded into shared memory, the thread block can execute the first internal layer operation of the fused layer (step 416). This internal layer can use at least the first tile as input, and may store its output either by updating the first tile directly or by writing its output to a separate intermediate tile. The specific behavior of the internal layer depends on the type of layer operation and the overall structure of the fused layer.

After completing the first internal layer operation, the thread block can proceed to execute the second internal layer operation (step 418). This internal layer operation may use at least the output of the first internal layer as input (e.g., the updated first tile or the intermediate tile, depending on the dataflow of the fused layer). Similar to the first internal layer, the second internal layer can store its output by either updating an existing tile or writing its output to a new output tile.

The fused layer can also implement additional internal layer operations as needed, depending on the complexity of the fused layer. A respective internal layer can use one or more tiles as input, and can produce one or more tiles as output, with intermediate tiles serving as a way to pass data between internal layers without accessing GPU global memory.

After executing the set of internal layers within the fused layer for the current tile-processing iteration, the thread block can store a final output tile to the appropriate location in a corresponding output tensor (step 420). In some embodiments, storing a tile may be performed by copying the values from the tile to the corresponding portion of the output tile. In some alternative embodiments, storing the tile may involve performing an accumulation operation (e.g., atomic-addition, or atomic-multiplication) or a reduction operation (e.g., atomic-maximum, or atomic-minimum) to produce the final result. The individual thread blocks can, for example, individually contribute to an output sum by performing atomic-addition operations onto cells of the output tensor that were initially set to zero (e.g., set to zero prior to step 408, when the individual GPU thread blocks diverged to different tile-processing iterations).

After performing step 420, the GPU thread block may then return to step 410 to select the next tile-processing iteration to process. The fused layer can continue executing loop 410-420 for individual GPU thread blocks until they have completed processing their corresponding tile-processing iterations. Once all GPU thread blocks have concluded their respective tile-processing iterations (e.g., by reaching the “no” path of step 412), the runtime execution of the various GPU thread blocks may converge, at which point the fused layer may complete its execution, and the output tensor is ready for use by the next layer in a corresponding neural network, which may include additional fused or non-fused layers.

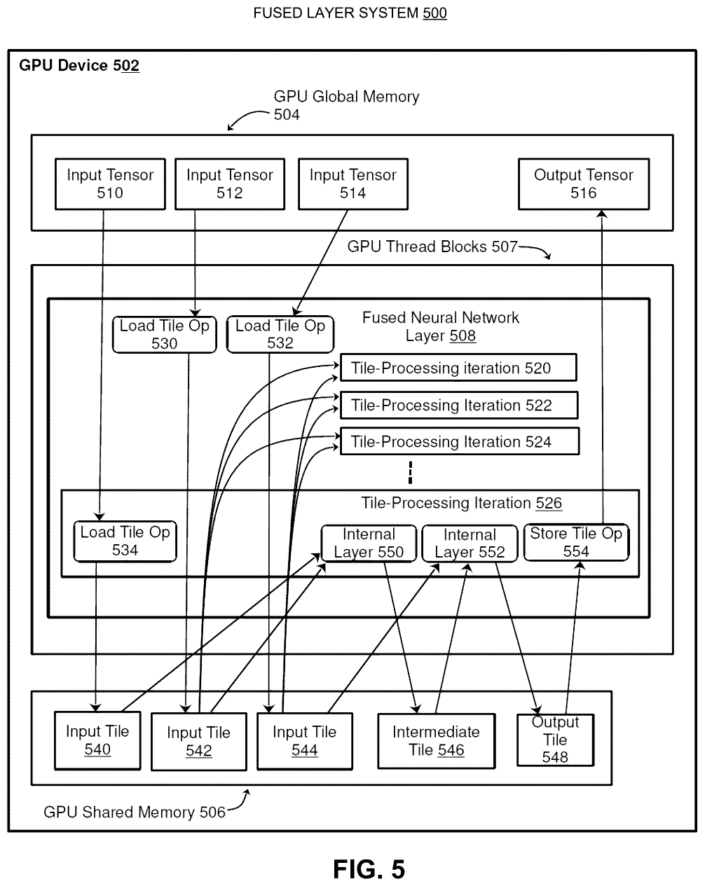

FIG. 5 illustrates a block diagram of a fused neural network layer system and architecture 500 (also referred to as “fused layer system 500” or “system 500” hereinafter) including multiple input tiles in accordance with some embodiments described herein. System 500 can be viewed as an extension of the architecture of fused layer system 200 of FIG. 2, by including mechanisms for processing multiple input tensors simultaneously. Note that fused layer system 500 includes a fused neural network layer 508 that can be implemented within a single GPU kernel that runs on GPU device 502.

In the exemplary implementation of FIG. 5, fused neural network layer 508 (or “fused layer 508”) can take at least three input tensors 510, 512, and 514 as inputs, which are initially stored in GPU global memory 504 of a GPU device 502. These input tensors may represent different types of data or features that need to be processed together by the fused layer 508.

The fused layer system 500 may also allocate a set of tiles 540-548 from GPU shared memory 506 for a respective GPU thread block of GPU thread blocks 507 (of GPU device 502), for use by one or more tile-processing iterations of the respective GPU thread block. For example, tiles 540-548 can be configured as input tiles 540-544, an intermediate tile 506 and an output tile 548. Fused layer 508 can select sizes of a respective tile (e.g., any of the set of tiles 540-548) to maximize utilization of the shared memory 506, while ensuring that there is sufficient space in shared memory 506 to allocate the set of tiles needed by fused layer 508.

During execution, fused layer 508 can load portions of input tensors 502, 504, and 506 into corresponding input tiles 540, 542, and 544 in the shared memory 506 of GPU device 502. For example, if input tensors 512 and 514 are sufficiently small to fit within input tiles 542 and 544, respectively, fused layer 508 may pre-load input tiles 542 and 544 from input tensors 512 and 514, respectively (e.g., by running load-tile operations 530 and 532 within fused layer 508 prior to configuring individual GPU thread blocks to run a corresponding set of tile-processing iterations).

Fused layer 508 may also configure individual thread block iterations to load input tile 540 (e.g., via a load-tile operation 534 within fused layer 508) from a portion of input tensor 510 that corresponds to the tile-processing iteration being performed by the corresponding thread block.

Fused layer 508 can then execute internal layers 550-552 at least on input tiles 540-544 in shared memory 506. The operations from these internal layers may involve computations that combine data from multiple input tiles, such as element-wise additions, concatenations, or matrix multiplications. Each layer within internal layers 550-552 can store intermediate results into one or more intermediate tiles in shared memory 506 (e.g., intermediate tile 546), and/or to output tile 548. By keeping intermediate results in shared memory 506, fused layer 508 can reduce the memory transactions from GPU global memory 504, which would incur significant performance overheads.

After fused layer 508 has executed neural network operations 550-552 on input and/or intermediate tiles 540-546, and has stored and/or accumulated computation results onto output tile 548, fused layer 508 can copy and/or accumulate contents of output tile 548 onto a portion of output tensor 516 that corresponds to the current tile-processing iteration through a store-tile operation 554 within fused layer 508.

In some embodiments, system 500 can configure fused layer 508 to repeat the above-described process of loading input tiles, running internal neural network layers, and writing output tiles until all portions of input tensors 510-514 have been processed.

### Example 1: Fused Dense Layer (Fused Fully-Connected Layer)

One use case for the disclosed fused neural network layer with multiple input tensors is to implement a dense or fully-connected layer. A dense or fully-connected layer is a type of neural network layer where each neuron in the layer may be connected to every neuron in the previous layer. This type of neural network layer is in contrast to other types of neural network layers, such as a convolutional layer, wherein each neuron is only connected to a local region of a previous layer. Dense layers may be used to perform feature aggregation and classification tasks in a neural network. A dense layer is generally implemented using a multiplication layer that multiplies the input activations by a weight matrix, and at least one of: a bias-addition layer that adds a bias vector to the result to produce the output activations, and an activation layer that performs an element-wise activation function.

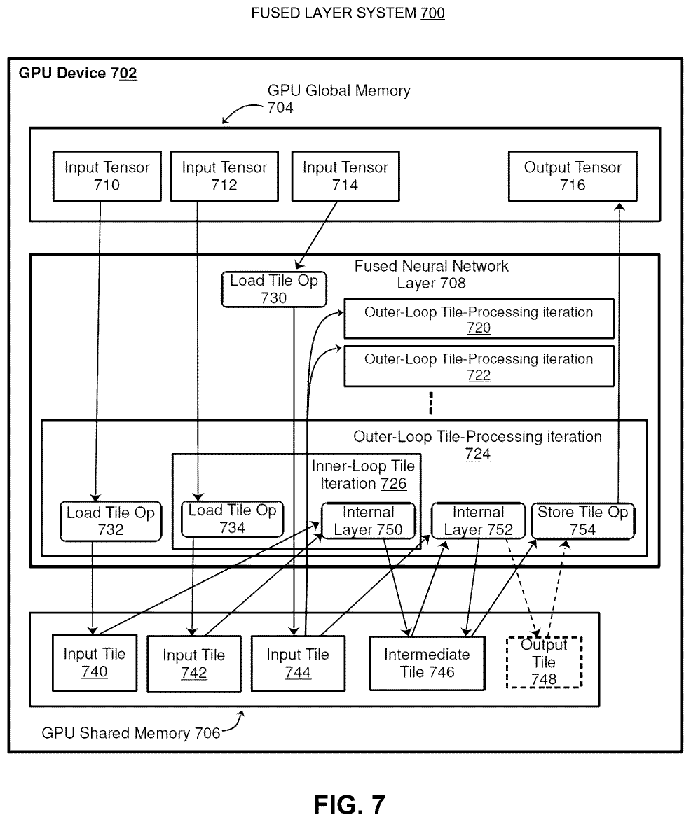

The example below will show how to implement a fused dense layer comprising a multiplication layer followed by a bias-addition layer. However, a fused dense layer that includes an internal activation layer (either in place of the internal bias-addition layer or in combination with the internal bias-addition layer) can implement the forward-pass and reverse pass of the internal activation layer as described below in Example 3 (in conjunction with FIG. 7).

In an exemplary implementation of the fused layer system, a dense layer can be implemented within a fused layer that includes both the corresponding multiplication layer and the corresponding bias-addition layer. With reference to FIG. 5, input tensor 510 may represent the activations from the previous layer to the dense layer, input tensor 512 may represent the weights of the dense layer, and input tensor 514 may represent the biases.

Oftentimes, the sizes of the weights tensor and the bias tensor may be sufficiently small so that each of the weights tensor and the bias tensor may be fitted within one iteration of a shared-memory tile. Hence, in some embodiments, fused neural network layer 508 may configure the shapes for input tiles 542 and 544 to the shapes of input tensors 512 and 514, respectively. Fused neural network layer 508 may perform load-tile operations 530-532 before any tile-processing iterations, such as to pre-load weight tensor 512 into tile 542, and to pre-load bias tensor 514 into tile 544.

Once fused layer 508 configures a respective thread block to load the weights and biases into tiles 542-544, the GPU thread block may then iterate across a subset of unique portions of input tensor 510 (e.g., portions of input tensor 510 that are not covered by other GPU thread blocks) to perform matrix multiplication operation (e.g., via internal layer 550), wherein the thread block may store its results onto intermediate tile 546. The GPU thread block may then execute the bias-addition operation (e.g., via internal layer 552), wherein the thread block may take intermediate tile 546 as input, to compute the output activations of the dense layer. The results of the bias-addition operation (e.g., via internal layer 552) may be stored into output tile 548. Next, fused layer 508 may copy the results from output tile 548 and write the results back to the corresponding portion of output tensor 516 through a store-tile operation 554 within fused layer 508.

Because fused layer 508 can perform the matrix multiplication operation and the bias-addition operation in a single GPU kernel (e.g., via internal layers 550-552), system 500 makes it possible for a respective tile-processing iteration 526 to re-use input tiles 542-544 within shared memory 506 while executing layer operations (e.g., the matrix-multiplication and bias operations) as they traverse various groups of rows of input tensor 510. Tile-processing iteration 526 of fused layer 508 can re-use the pre-loaded weight values in tiles 542-544 while executing the matrix-multiplication internal layer 550 traversing various groups of rows of input tensor 510. Tile-processing iteration 526 can also re-use the pre-loaded bias values in tile 544 while executing the bias-addition internal layer 552.

In some embodiments, fused layer 508 may use one tile in place of both intermediate tile 546 and output tile 548. These embodiments can preserve additional space in GPU shared memory 506 for the remaining tiles, which can allow for allocating more rows into input tile 540 and output tile 548.

In some further embodiments, fused layer system 500 can be extended to support input tensors of various sizes, depending on the requirements of the specific fused neural network being implemented. For example, fused layer 508 can be configured to execute load-tile operation 530 and/or load-tile operation 532 within the tile-processing iterations (e.g., tile-processing iteration 526) in order to load tile 542 and/or tile 544 during a respective tile-processing iteration. These embodiments may be necessary, for example, if tile 542 (or tile 544) is not sufficiently large to hold the contents of input tensor 512 (or tensor 514), or if tile 542 (or tile 544) needs to hold a portion of input tensor 512 (or tensor 514) that matches a portion of input tensor 510 held by input tile 540.

### Back-Propagation Pass

During the back-propagation pass of the fused dense layer, fused layer 508 can compute the gradients of the loss function with respect to the layer's inputs (e.g., input tensor 510) and with respect to the parameters (e.g., input tensors 512 and 514). Typically, the back-propagation process involves two main steps: the gradient computation for the bias-addition operation and the gradient computation for the matrix-multiplication operation.

More specifically, fused layer 508 can load a tile for the gradient of the loss function with respect to the output of the bias-addition operation (which is also referred to as “dOutput tile” hereinafter, not shown in FIG. 5) from the corresponding tensor (which is also referred to as “dOutput tensor” hereinafter, not shown in FIG. 5). The dOutput tensor is typically provided by the next layer in the neural network during the back-propagation pass. The dOutput tile can have the same shape as output tile 548 from the forward pass.

Next, fused layer 508 can compute the gradient of the loss function with respect to the biases (e.g., received through input tensor 514). Because the bias-addition operation is an element-wise addition, the gradient with respect to the biases is simply equal to the gradient of the output (e.g., the dOutput tile). Fused layer 508 can accumulate the values of the dOutput tile into a gradient tensor for the biases (which is also referred to as “dBias tensor” hereinafter, not shown in FIG. 5) using atomic-add operations to ensure correct accumulation across multiple thread blocks.

To compute the gradient with respect to the weights (e.g., received through input tensor 512), fused layer 508 can perform a matrix multiplication operation between the transpose of the input activations (e.g., received through input tensor 510) and the dOutput tile. Similar to the forward pass, fused layer 508 can perform this matrix-multiplication operation by configuring one or more GPU thread blocks to iterate across different portions of input tensor 510, and a respective GPU thread block can perform the matrix-multiplication operation within the associated tile-processing iterations (e.g., tile-processing iteration 526). The resulting gradient tensor for the weights (which is also referred to as “dWeights tensor” hereinafter, not shown in FIG. 5) can have the same shape as input tensor 512 from the forward pass.

Finally, to compute the gradient with respect to the input activations (e.g., received through input tensor 510), fused layer 508 can perform a matrix multiplication operation between the dOutput tile and the transpose of the weights (e.g., received through input tensor 512). Fused layer 508 can perform this matrix-multiplication operation within the same tile-processing iterations that were used to compute the gradient with respect to the weights. The resulting gradient tensor for the input activations (which is also referred to as “dInput tensor” hereinafter, not shown in FIG. 5) can have the same shape as input tensor 510 from the forward pass.

During the back-propagation pass, fused layer 508 can efficiently utilize the GPU's shared memory and parallel processing capabilities. For example, the tile-processing iterations (e.g., tile-processing iteration 526) can accumulate the gradients for the biases and the weights in shared memory tiles (e.g., the dBias tile and dWeights tile) before these gradient values are written back to the corresponding global memory tensors (e.g., dBias tensor and dWeights tensor, respectively). As a result, the disclosed back-propagation pass based on fused layer system 500 minimizes the number of global memory accesses to improve performance of the internal layers.

Moreover, by fusing the matrix multiplication and bias-addition operations into a single GPU kernel, fused layer 508 can avoid the need to write intermediate results back to global memory 504 between the gradient computations of these two operations. This fusing process reduces memory traffic and improves the overall efficiency of the back-propagation pass, which can improve the overall efficiency of the neural-network training process.

### Example 2: A Fused Layer of Combined Convolution and Bias-Addition Operations

Another use case for the disclosed fused neural network layer, such as fused layer 508, is to combine a convolution operation with a bias-addition operation. Convolution is a fundamental operation in convolutional neural networks (CNNs) that can extract local features from the input data. A bias-addition operation can shift rows of the output of the convolution operation by a learnable constant vector.

In this example, fused layer 508 may begin by loading input tile 542 with a kernel created for the convolution operation, from input tensor 512. Fused layer 508 may also load the bias vector onto input tile 544, from input tensor 514.

Fused layer 508 may then execute the following two internal layers within a respective tile-processing iteration:
1. Internal layer 550: internal layer 550 executes a convolution operation on input tile 540. This can involve sliding the kernel from input tile 542 (e.g., a small matrix of learnable weights) over input tile 540, and computing the dot product between the kernel and the corresponding input values at each position. Internal layer 550 can store the output of the convolution operation into intermediate tile 546, which may have the same dimensions as input tile 540.
2. Internal layer 552: internal layer 552 may then execute a bias-addition operation by adding a bias term to cells in intermediate tile 546. The bias term can be a learnable parameter that configures fused layer 508 to shift the value of row-vector cells of the output of the convolution by a constant value. Adding the bias vector to intermediate tile 546 is an element-wise operation across intermediate tile 546 that can be performed efficiently in parallel. Internal layer 552 can store the output of the bias-addition operation back into intermediate tile 546, thereby overwriting the original convolution output.

Note that fusing the convolution and bias addition operations into one fused layer allows fused layer system 500 to keep the intermediate convolution output in GPU shared memory 506, thereby avoiding the need to write the intermediate output back to GPU global memory 504 and then read the intermediate output again for the bias-addition operation. This fusing operation configures fused layer system 500 to reduce memory transactions to GPU global memory, compared to a system where the convolution layer and the bias addition layer are implemented in separate GPU kernels.

### Back-Propagation Pass

During the back-propagation pass of the fused convolution and bias-addition layer (which may be implemented as fused layer 508), input tensor 510 may correspond to the gradient of the loss function with respect to the output of fused layer 508, wherein fused layer 508 may receive input tensor 510 from the next layer of the larger neural network. During a respective tile-processing iteration (e.g., tile-processing iteration 526), the corresponding GPU thread block may load a portion of the loss gradient onto input tile 540.

Internal layer 550 may then compute the gradient of the bias-addition operation for the cells in input tile 540. Because the gradient of the bias-addition operation is simply the gradient of the loss function with respect to its output, the gradient remains unchanged, and thus internal layer 552 can operate on input tile 540 to compute the final gradients.

Internal layer 552 may compute the gradients of the convolution operation with respect to the kernels (wherein the computed gradients are stored into a dKernel tile, not shown in FIG. 5), and with respect to the input (wherein the computed gradients are stored into a dInput tile, not shown in FIG. 5). The gradient computation for the convolution operation can take as input: (1) an input tile (not shown in FIG. 5, which can be loaded from the forward-pass input tensor's values), (2) an output tile (not shown in FIG. 5, which can be loaded form the fused layer's output tensor), and (3) tile 540, which stores the gradient of the loss with respect to the convolution output (which can be loaded from tensor 516, corresponding to the fused layer's incoming gradients relative to its output tensor).

To compute the gradient with respect to the input (wherein the computed gradients are stored into the dInput tile), fused layer 508 may perform a transposed convolution operation between input tile 540 (which stores the incoming gradients) and input tile 542 (which stores the convolution kernels). This operation effectively propagates the incoming gradients from input tile 540 onto the dInput tile, taking into account the connectivity and weights of the convolution kernels.

To compute the gradient with respect to the kernels (wherein the computed gradients are stored into the dKernel tile), fused layer 508 can perform a convolution operation between input tile 540 (which stores the incoming gradients) and intermediate tile 546 (which stores the bias vector). This operation calculates the gradients of the convolution kernels by correlating the input values with the gradients of the output, effectively measuring how changes in the kernel weights affect the loss.

Fused layer 508 may then accumulate the computed gradients relative to the input onto output tensor 516, using a store-tile operation that reads values from the dInput tile. Fused layer 508 may also accumulate the computed gradients relative to the kernels onto another output tensor (not shown), using a store-tile operation that reads values from the dKernel tile. In some embodiments, fused layer 508 may accumulate values from a tile onto a tensor by performing atomic-add operations.

Note that examples 1-2 above demonstrate how the architecture of the disclosed fused layer system 500 can optimize different combinations of neural network computations during inference, which include keeping intermediate results in shared memory that is faster than GPU global memory with less latencies. Note that specific operations and dataflow described above in conjunction with fused layer system 500 can be customized to suit the needs of different neural network architectures and applications, such as combining multiple element-wise operations or fusing more complex operations like attention mechanisms or recurrent units.

Note also that in both of the examples above, the fused layer can also take advantage of the GPU's parallel processing capabilities and memory hierarchy during the back-propagation pass by computing the gradients for multiple tiles simultaneously. More specifically, each respective thread block among multiple thread blocks can compute the gradients for a different tile-processing iteration independent from other thread blocks, and can use atomic operations to accumulate the gradient results from a gradient tile into the corresponding portion of the target gradient tensor to prevent potential race conditions from causing erroneous values to be written.

A Fused Neural Network Layer with Nested Loops

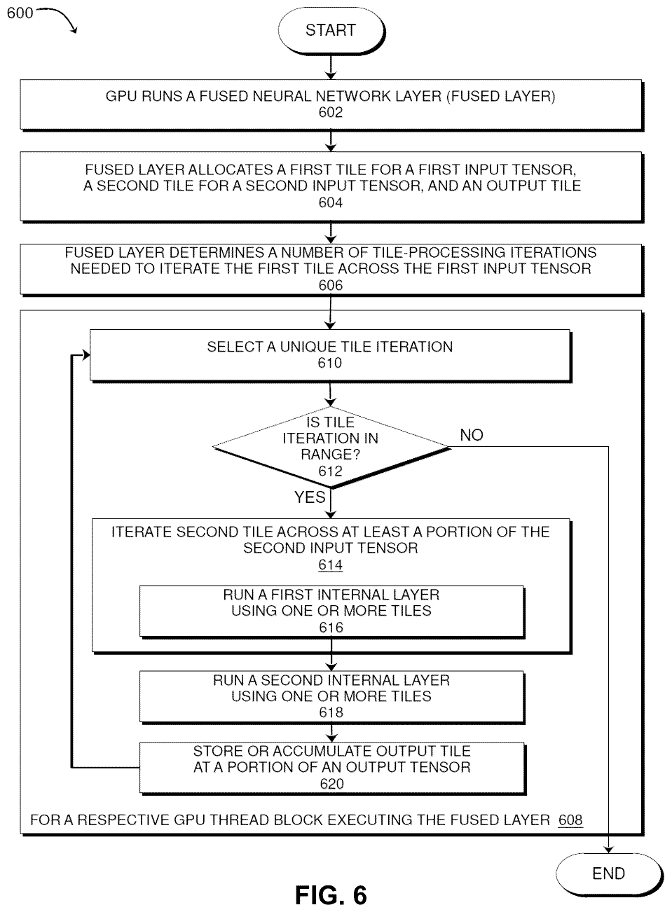

FIG. 6 illustrates a process 600 for executing a fused neural network layer comprising nested tile-processing iterations in accordance with some embodiments described herein. This process extends the basic fused layer execution flow 400 described in conjunction with FIG. 4 by introducing an additional level of tiling and iteration to handle more complex operations that may require nested loops.

Process 600 can begin with the GPU running a fused neural network layer (or “the fused layer”) (step 602). The fused layer can allocate the necessary tiles for various computations (step 604), which may include at least a first tile for a first input tensor, a second tile for a second input tensor, and an output tile for storing the results. The fused layer may then determine the number of tile-processing iterations needed to traverse the first input tensor (step 606). This step is similar to step 406 of process 400 described in FIG. 4. However, in process 600, the tile-processing iterations for the first input tensor can form the outer loop of the nested iteration structure.

After determining the number of tile-processing iterations, the fused layer can configure the set of GPU thread blocks to collectively perform the tile-processing iterations. More specifically, a respective GPU thread block in the set of GPU thread blocks can perform a sequence of steps 610-620 for at least a subset of the tile-processing iterations, in parallel to the tile-processing iterations performed by the other GPU thread blocks (step 608). For the respective GPU thread block executing the fused layer, the respective GPU thread block can select a unique tile-processing iteration that no other thread block will select (step 610). For example, in some embodiments, the respective thread block can select its tile-processing iterations by striding across the total number of tile-processing iterations, with each thread block starting at its unique block identifier, and the stride length being set to the number of GPU thread blocks.

The thread block may check whether the selected tile-processing iteration is within the valid range of iterations (step 612). If not, the GPU thread block may exit the loop, or alternatively wait for the other thread blocks to complete their iterations. Otherwise, the GPU thread block can proceed to an inner loop of process 600, which can involve iterating the second tile across at least a portion of the second input tensor (step 614). The specific iteration pattern for the second tile may vary depending on the internal layer being performed. For example, the second tile may implement a “windowing” algorithm that may iterate over a set of rows in the second input tensor that are within a predetermined distance from the set of rows of the first input tensor that has been loaded into the first tile.

The GPU thread block can execute at least a first internal layer (step 616) within a tile-processing iteration of the inner loop, and can execute at least a second internal layer (step 618) in the outer loop iteration. In some embodiments, the GPU thread block may execute the second tile-processing iteration after executing the inner loop, so that the thread is configured to post-process the results of the inner loop. In some alternative embodiments, the GPU thread block may execute the second tile-processing iteration before executing the inner loop, so that the thread is configured to initialize an intermediate tile that may be further processed by the inner loop. A respective internal layer may use the first tile, the second tile, and/or additional intermediate tiles as inputs, and may store their outputs in the same tiles or in separate output tiles. The specific operations and dataflow can be customized based on the requirements of the specific fused layer.

After the thread block completes executing the inner layers of the inner loop and the outer loop, the thread block may store or accumulate the final values of the output tile into a portion of the output tensor that corresponds to the outer loop iteration (step 620). The thread block can either directly store these values, or perform an accumulation operation (e.g., an atomic-add, an atomic-min, or an atomic-max operation) to combine its results with results accumulated by other thread blocks into the same region of GPU global memory. The thread block can then return to step 610 to select the next tile-processing iteration for the first input tensor. The thread block can continue this process until it has completed its selected set of tile-processing iterations, and the fused layer can complete its execution when the GPU thread blocks collectively have iterated across the input tiles (e.g., the first and second input tiles).

By using the above nested tile-processing iterations, the fused neural network layer can efficiently implement complex operations that may require multiple levels of loops, such as matrix multiplication, convolution with dilation, or self-attention. The specific iteration patterns and tile sizes can be tuned to optimize the performance of process 600 based on the characteristics of the input tensors and the available GPU resources.

Note that the above-described nested tile-processing iteration technique configures the GPU's thread blocks to independently process a different pair of tiles from the two input tensors, which can lead to significant performance improvements compared to traditional implementations that use separate kernels for the first and the second internal layers, and that would require frequent data movement between global memory and shared memory.

FIG. 7 illustrates a block diagram of a fused neural network layer system 700 (or “fused layer system 700” hereinafter) that uses tiling to perform computations involving two nested loop iterations in accordance with some embodiments described herein. In some embodiments, fused layer system 700 can be a variation of fused neural network layer system 200 shown in FIG. 2, with support features for efficiently executing neural network operations that may require nested looping over input tensors.

Fused layer system 700 can include a fused neural network layer 708 (or “fused layer 708”) that can take two or more tensors as input, such as input tensors 710-714. Input tensors 710-714 can be stored in the global memory 704 of the GPU, and input tensors 710 and 712 may represent data that needs to be processed in a Cartesian-product traversal, such as for a self-attention mechanism, or computing a matrix multiplication or a convolution from input tensors 710 and 712.

During execution, fused neural network layer 708 can first pre-load, from global memory 704 and prior to running the outer loop, a tile whose contents will not change during iterations of the outer loop. For example, if input tensor 714 (e.g., which may store a bias vector) is sufficiently small to fit within one iteration of input tile 744, fused neural network layer 708 can run a load-tile operation 730 to load input tensor 714 into input tile 744 in shared memory 706. The contents of input tile 744 may then remain constant during iterations of the two nested loops, thereby allowing fused layer 708 to obtain the contents of input tensor 714 from input tile 744 in shared memory 706, without incurring the slower transactions from input tensor 714 in global memory 704.

Fused layer 708 can then configure a plurality of GPU thread blocks, wherein each respective GPU thread block in the plurality of configured GPU thread blocks is configured to iterate an input tile 740 across a unique portion of input tensor 710 (e.g., a portion that is not accessed by other tile-processing iterations of input tensor 710), to implement an outer-loop tile-processing iteration 724. These tile-processing iterations across input tensor 710, executed by the plurality of configured GPU thread blocks, collectively implement the outer loop of a Cartesian-product traversal of input tensors 710 and 712. Fused layer 708 may then run load-tile operation 732 during each respective outer-loop tile-processing iteration 724 to load a corresponding portion of input tensor 710 into input tile 740 in shared memory 706.

The various GPU thread blocks may also run a nested loop that can use an input tile 742 to iterate across portions of input tensor 712, such as by running a load-tile operation 734 during a respective inner-loop iteration to load a corresponding portion of input tensor 712 into input tile 742. Fused layer 708 may select the sizes of input tiles 740-744 to balance the utilization of shared memory 706 with the number of tiles that need to be allocated in shared memory 706.

A respective GPU thread block of the plurality of configured GPU thread blocks of fused neural network layer 706 may then perform the loop computation on the input tensors 710 and 712, such as by executing internal layers 750-752. This can, for example, involve performing a Cartesian product traversal between vectors of input tiles 740 and 742, iterating over pairs of elements from the two vectors, and computing a result for each pair. A respective vector of tile 740 or 742 may, for example, be a row-vector or a column-vector of the corresponding tile. The specific type of vector (e.g., row-vector or column-vector) and the computation performed between a pair of vectors, can depend on the neural network operation being implemented. Some examples of these neural network operations can include, but is not limited to, a matrix multiplication, a convolution, or an attention mechanism operation.

In some embodiments, internal layer 750 can store or accumulate its results into an intermediate tile 746, whereas internal layer 752 can store or accumulate its results into intermediate tile 746 and/or an output tile 748. For example, internal layer 750 may perform computations for Cartesian product traversal between a pair of vectors in input tiles 740 and 742, and internal layer 750 can accumulate its intermediate results onto intermediate tile 746, thereby reducing the need for frequent access global memory 704 within the inner loops that would otherwise degrade system performance.

Moreover, the results that the inner loops accumulate onto intermediate tile 746 can be used as “intermediate results” by any subsequent internal layer operation of outer-loop tile-processing iteration 724. The subsequent internal layer operation can perform an additional computation on the intermediate results without having to access global memory 704. For example, after a respective GPU thread block completes a sequence of nested tile-processing iteration 726 that traverses a portion of input tensor 712, the GPU thread block may return to outer-loop tile-processing iteration 724 to execute an internal layer 752. Internal layer 752 may operate at least on intermediate tile 746, and can store its result onto output tile 748 in shared memory 706. In some embodiments, the GPU thread block can run store-tile operation 754 to copy the contents of output tile 748 onto a corresponding portion of output tensor 716.

Alternatively or additionally, store-tile operation 754 may accumulate the contents of output tile 748 onto the corresponding portion of output tensor 716, such as by performing synchronization mechanisms that can include atomic operations or reduction techniques between a cell of output tile 748 and a corresponding cell of output tensor 716. These atomic operations can include, but are not limited to, an atomic-add operation, an atomic-max operation, or an atomic-min operation. These synchronization mechanisms can ensure that the final result stored in intermediate tile 746 has not become corrupted due to race conditions between concurrent read-modify-write operations to cells in shared memory 706.

Fused neural network layer 708 can repeat the above-described process of traversing iterations of input tile 742 (via one or more inner-loop tile-processing iteration 726) per iteration of input tile 740, and storing or accumulating the results in output tile 478 onto output tensor 716, until fused neural network layer 708 has traversed the tile-processing iterations of input tile 740 necessary for processing input tensors 710 and 712.

### Example 3: A Fused Layer of Combined Matrix-Multiplication and Activation Operations

Similar to Example 1, a use case for a fused neural network layer 708 with two nested tile-processing iterations can include a fused-layer implementation of a dense layer or fully-connected layer whose matrix multiplication operation requires two nested tile-processing iterations, followed by either a bias-addition operation or an activation function (through an “activation layer”). This layer combination may oftentimes be a fundamental building block in many neural network architectures, such as to implement a large fully-connected layer, an attention mechanism, and a recurrent neural network.

The example below will demonstrate how to implement a fused dense layer comprising a multiplication layer followed by an internal activation layer. However, a fused dense layer that includes nested loop iterations and an internal bias-addition layer (which is either in place of the internal activation layer or in sequence before or after the internal activation layer) can implement the forward-pass and reverse pass of the internal bias-addition layer as described in Example 1 in conjunction with FIG. 5.

When implementing such a layer combination, it may become necessary for fused layer 708 to implement two nested tile iterators (e.g., tile-processing iterations 724-726): one is used for an input tensor 710 and the other is used for an input tensor 712 of the multiplication layer, especially when input tensor 710 and input tensor 712 are too large to fit into a single input tile.

In some embodiments, input tensor 710 may represent the activations from the previous layer, input tensor 712 may represent the weights of the dense layer, and input tensor 714 may represent the corresponding biases. In these embodiments, if the bias vector of input tensor 714 is sufficiently small to fit in one input tile, fused neural network layer 708 would be able to pre-load bias tensor 714 into input tile 744, such as by performing load-tile operation 730 before running any outer-loop tile-processing iteration. Then, fused layer 708 may configure a respective GPU thread block to iterate across unique portions of input tensor 710 (e.g., portions of input tensor 710 that are not selected by other GPU thread blocks), and the GPU thread block can iterate across portions of input tensor 712.

Let's consider the case of multiplying two matrices A and B to produce an output matrix C, where A has dimensions (M, K), B has dimensions (K, N), and C has dimensions (M, N). During the forward pass, fused layer 708 can first allocate input tiles 740 and 742 for matrices A and B: the allocated input tile 740 for matrix A may have dimensions (T_M, T_K), and the allocated input tile 742 for matrix B may have dimensions (T_K, T_N); and the allocated intermediate tile 746 for matrix C may thus have dimensions (T_M, T_N).

Fused layer 708 may select dimensions T_M, T_K, and T_N to optimize the utilization of shared memory 706, and to ensure that tiles 740-748 fit within GPU shared memory 706. For example, fused neural network layer 708 may configure dimension T_K for columns of input tile 740 and rows of input tile 742 to include the number of columns in input tensor 710. Moreover, fused neural network 708 may configure dimension T_M for input tile 740 to have the maximum number of rows that can fit within the cells allocated in input tile 740. However, regarding dimension T_N, if input tensor 712 is stored in a row-major format, fused neural network layer 708 may configure input tile 742 to achieve coalesced memory accesses from input tensor 712 in GPU global memory 704 by setting dimension T_N to the minimum of: 32 columns (e.g., a size of a GPU warp) or a number of columns in input tensor 712.

Fused layer 708 may then perform the matrix multiplication operation 750 and activation operation 752 using nested tile-processing iterations configured for one or more GPU thread blocks. Specifically, one or more GPU thread blocks can run in parallel, wherein a respective GPU thread block can stride over a subset of unique iterations of the outer loop, and wherein collectively the one or more configured GPU iterate over the tiles of matrix A along the M dimension (e.g., using outer-loop tile-processing iteration 724 for a respective loop iteration). Then, a respective GPU thread block can run the inner loop to iterate over the tiles of matrix B along the N dimension that correspond to a current tile of matrix A (e.g., using inner-loop tile-processing iteration 726 for a respective loop iteration).

An outer-loop tile-processing iteration 724 can include a load-tile operation 732 to load input tile 740 from a corresponding portion of input tensor 710, and may run a sequence of one or more inner-loop tile-processing iterations 726 that together perform a cross-product operation between the contents of input tile 740 and one or more portions of input tensor 712. For example, a respective inner-loop tile-processing iteration 726 may perform a load-tile operation 734 to load a portion of input tensor 712 onto input tile 742.

Inner-loop tile-processing iteration 726 may then execute an internal layer 750 that can process a pair of tile-processing iteration instances (e.g., A_tile and B_tile) in the nested loop, which can include a matrix multiplication between input tiles 740 and 742, and may accumulate the results into intermediate tile 746 (e.g., to store the contents for C_tile). This can involve computing the dot product between rows of A_tile and columns of B_tile, and summing the results into the corresponding element of C_tile.

For the second layer operation, fused layer 708 can run internal layer 752 within the outer loop (e.g., outer-loop tile-processing iteration 724) to perform an activation function, such as ReLU, to the elements of C_tile stored in intermediate tile 746. The activation function can introduce non-linearity into the computation, thereby facilitating the neural network to learn more complex patterns. In some embodiments, internal layer 752 may store the output of the activation function back into intermediate tile 746, thereby overwriting the previous values.

After the execution of internal layer 752 completes, intermediate tile 746 can contain the final C_tile values for the corresponding portion of output tensor 716 (e.g., output matrix C). Fused layer 708 may then run store-tile operation 754 to store intermediate tile 746 into the corresponding portion of output tensor 716.

The above-described nested tile-processing iteration technique allows fused layer system 700 to achieve efficient use of GPU threads during matrix multiplication operation across multiple thread blocks, while minimizing the number of accesses to GPU global memory 704 by re-using the contents stored in intermediate tile 746 during the executions of fused layer 708. Each GPU thread block can independently compute a different tile of the output matrix C by loading the corresponding tiles from matrices A and B into GPU shared memory 706, performing the matrix multiplication and activation operations that store their results into intermediate tile 746, and then storing the contents of intermediate tile 746 back to output tensor 716 in GPU global memory 704.

### Back-Propagation Pass:

During the back-propagation pass, fused layer 708 can compute the gradients of the loss function with respect to the layer's inputs (e.g., matrices A and B), and can compute the gradients of the loss function with respect to a set of parameters (if any). Fused layer system 700 can implement the internal-layer operations for the back-propagation pass as separate functions that operate on tiles in GPU shared memory 706. These internal back-propagation layer operations and shared-memory tiles are not explicitly shown in FIG. 7, but are described below in detail.

Fused layer 708 can also take as inputs at least an activation-function tensor (e.g., C_tensor, storing the output of the activation function) and an activation-function gradient (e.g., a dC_tensor, storing a gradient of the loss function with respect to the output of the activation function). Similar to the forward-pass traversal, one or more GPU thread blocks can run in parallel during the backward-pass, wherein a respective GPU thread block can use an outer-loop tile-processing iteration (e.g., outer-loop tile-processing iteration 724) to stride over a subset of unique iterations of the outer loop. The one or more GPU thread blocks iterate over the tiles of the C_tensor and the dC_tensor along the M dimension (e.g., using outer-loop tile-processing iteration 724 for a respective loop iteration), to load the tile portions from the C_tensor and the dC_tensor into their respective shared-memory tiles. Then, a respective GPU thread block can run the inner loop to iterate over the tiles of the A_tensor and B_tensor (e.g., the forward-pass input tensors) along the N dimension (e.g., using inner-loop tile-processing iteration 726 for a respective outer-loop iteration for A_tensor and B_tensor).

More specifically, outer-loop tile-processing iteration 724 can compute the gradient of the activation function with respect to its input by taking as inputs the two shared-memory tiles C_tile and dC_tile, and performing an element-wise computation that performs the back-propagation computation for the activation function. Outer-loop tile-processing iteration 724 can store the result into a shared-memory tile referred to as “dZ_tile” (not shown), which can hold the gradient of the loss with respect to the output of the matrix multiplication, for the current outer-loop tile-processing iteration (e.g., outer-loop tile-processing iteration 724).

Then, a respective outer-loop tile-processing iteration 724 can compute the matrix multiplication gradients using the A_tile and the B_tile, and the dZ_tile. To compute the matrix multiplication gradient, an inner loop can iterate over the tiles of the A_tensor and B_tensor (e.g., the forward-pass input tensors) along the N dimension that correspond to the outer-loop tiles being processed for C_tensor and dC_tensor. Inner-loop tile-processing iteration 726 provides an example of a respective inner-loop tile-processing iteration.

The inner layer operation (for matrix multiplication) can compute the gradient with respect to input matrix A by performing matrix multiplication between the dZ_tile and the transpose of B_tile, accumulating the results into another tile (hereinafter referred to as “dA_tile”, not shown) in GPU shared memory 706. The inner layer operation can also compute the gradient with respect to input matrix B by performing matrix multiplication between the transpose of A_tile and the dZ_tile, accumulating the results into another tile (hereinafter referred to as “dB_tile”, not shown) in GPU shared memory 706.

Outer-loop tile-processing iteration 724 can accumulate the gradients stored in dA_tile and dB_tile for its current iteration onto the corresponding tensors in GPU global memory 704 (hereinafter referred to as “dA_tensor” and “dB_tensor”, respectively, also not shown), across all tile-processing iterations using atomic operations (e.g., atomic-addition) to ensure that race conditions between threads of one GPU thread blocks do not interfere with a read-modify-write operation by a thread of another different GPU thread block.

In some embodiments, fused layer system 700 can tune the specific tile sizes and iteration patterns for the back-propagation pass based on one of the following: the dimensions of the input matrices; the available shared memory per thread block; and other characteristics of the GPU architecture. Fused layer system 700 can also be extended to handle other variations of matrix multiplication during the forward pass and the back-propagation pass, such as batched matrix multiplication or matrix-vector multiplication.

While this patent document contains many specifics, these should not be construed as limitations on the scope of any disclosed technology or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for executing, by a graphics processing unit (GPU), a fused neural network layer that implements a sequence of neural network layer operations, the method comprising:
loading a first tile of a first input tensor of the fused neural network layer, from a first global-memory array allocated for the first input tensor in a global memory of the GPU, into a first shared-memory array allocated for the first tile in a shared memory of the GPU, wherein the first tile comprises a partition of the first input tensor of a first size and shape for processing the fused neural network layer during a first tile-processing iteration;
performing, by the GPU, a first neural network layer operation of the sequence of neural network layer operations, the first neural network layer operation comprising:
reading a first value from a first cell of the first tile;
generating a second value using a computation from the first neural network layer operation that operates at least on the first value; and
updating a second cell of a second shared-memory array allocated for a second tile in the shared memory of the GPU, to store the second value into the second tile, thereby storing intermediate values of the fused neural network layer into a portion of the shared memory of the GPU instead of writing the intermediate values into a portion of the global memory of the GPU; and
performing, by the GPU, at least one additional neural network layer operation of the sequence of neural network layer operations, the at least one additional neural network layer operation comprising:
generating a third value using computations from the at least one additional neural network layer operation, which operate at least on the second value in the second tile; and
updating a third cell of a third shared-memory array in the shared memory of the GPU to store the third value; and
storing the third cell to an output tensor of the fused neural network layer in the global memory of the GPU.

2. The method of claim 1, wherein performing a respective neural network layer operation of the fused neural network layer comprises:
calling a function that corresponds to the respective neural network layer operation, wherein the function takes at least the first tile or the second tile as function arguments.

3. The method of claim 1, wherein performing the first neural network layer operation further comprises:
iterating, by the GPU, a third tile across one or more portions of a second input tensor in the global memory of the GPU, for a respective iteration of the first tile across the first input tensor, wherein during a respective iteration of the third tile, the method further comprises:
loading the third tile from a portion of the second input tensor that corresponds to the tile iteration of the third tile;
generating the second value by performing the first neural network layer operation, which requires two nested traversals of the first and second input tensors using the first tile and the third tile; and
updating the second cell by accumulating the second value into the second cell using an operation selected from the group consisting of addition, maximum comparison, and minimum comparison.

4. The method of claim 3, wherein the two or more neural network layer operations that require two nested traversals of the input tensors are selected from the group comprising:
a matrix multiplication operation;
a convolution operation;
a cross-correlation operation;
an attention mechanism;
an outer product operation;
a tensor contraction operation;
a distance computation between pairs of elements from the first input tensor and the second input tensor; and
a similarity computation between pairs of elements from the first input tensor and the second input tensor.

5. The method of claim 1, wherein a respective neural network layer operation is selected from the group comprising:
an element-wise layer operation;
a normalization layer operation; and
a pooling layer operation.

6. The method of claim 5, wherein the element-wise layer operation is selected from the group comprising:
an activation function;
an element-wise arithmetic operation;
a dropout operation; and
a bias-addition operation.

7. The method of claim 5, wherein the normalization layer operation is selected from the group comprising:
a batch normalization operation;
a layer normalization operation; and
an instance normalization operation.

8. The method of claim 5, wherein the pooling layer operation is selected from the group comprising:
a max pooling operation;
a min pooling operation; and
an average pooling operation.

9. The method of claim 1, wherein each of the first tile and the second tile includes:
metadata comprising shape information that indicates a length for a respective dimension of the associated tile; and
one or more cells for storing numeric values across one or more dimensions of the associated tile.

10. The method of claim 1, wherein the sequence of neural network layer operations of the fused neural network layer operate one or more tiles in the shared memory of the GPU, without invoking additional read or write operations to a global-memory array in a global memory region of the GPU.

11. The method of claim 1, wherein the sequence of neural network layer operations of the fused neural network layer is executed by the GPU using a single GPU kernel.

12. A non-transitory computer-readable storage medium storing instructions that when executed by a computer cause the computer to perform a method for executing a fused neural network layer that implements a sequence of neural network layer operations, the method comprising:
loading a first tile of a first input tensor of the fused neural network layer, from a first global-memory array allocated for the first input tensor in a global memory of a graphics processing unit (GPU), into a first shared-memory array allocated for the first tile in a shared memory of the GPU, wherein the first tile comprises a partition of the first input tensor of a first size and shape for processing the fused neural network layer during a first tile-processing iteration;
performing a first neural network layer operation of the sequence of neural network layer operations, the first neural network layer operation comprising:
reading a first value from a first cell of the first tile;
generating a second value using a computation from the first neural network layer operation that operates at least on the first value; and
updating a second cell of a second shared-memory array allocated for a second tile in the shared memory of the GPU, to store the second value into the second tile, thereby storing intermediate values of the fused neural network layer into a portion of the shared memory of the GPU instead of writing the intermediate values into a portion of the global memory of the GPU; and
performing at least one additional neural network layer operation of the sequence of neural network layer operations, the at least one additional neural network layer operation:
generating a third value using computations from the at least one additional neural network layer operation, which operate at least on the second value in the second tile; and
updating a third cell of a third shared-memory array in the shared memory of the GPU to store the third value; and
storing the third cell to an output tensor of the fused neural network layer in the global memory of the GPU.

13. The non-transitory computer-readable storage medium of claim 12, wherein performing a respective neural network layer operation of the fused neural network layer involves calling a function that corresponds to the respective neural network layer operation, wherein the function takes at least the first tile or the second tile as function arguments.

14. The non-transitory computer-readable storage medium of claim 12, wherein performing the first neural network layer operation further comprises:
iterating, by the GPU, a third tile across one or more portions of a second input tensor in the global memory of the GPU, for a respective iteration of the first tile across the first input tensor, wherein during a respective iteration of the third tile, the method further comprises:
loading the third tile from a portion of the second input tensor that corresponds to the tile iteration of the third tile;
generating the second value by performing the first neural network layer operation, which requires two nested traversals of the first and second input tensors using the first tile and the third tile; and
updating the second cell by accumulating the second value into the second cell using an operation selected from the group consisting of addition, maximum comparison, and minimum comparison.

15. The non-transitory computer-readable storage medium of claim 14, wherein the two or more neural network layer operations that require two nested traversals of the input tensors are selected from the group comprising:
a matrix multiplication operation;
a convolution operation;
a cross-correlation operation;
an attention mechanism;
an outer product operation;
a tensor contraction operation;
a distance computation between pairs of elements from the first input tensor and the second input tensor; and
a similarity computation between pairs of elements from the first input tensor and the second input tensor.

16. The non-transitory computer-readable storage medium of claim 12, wherein a respective neural network layer operation is selected from the group comprising:
an element-wise layer operation;
a normalization layer operation; and
a pooling layer operation.

17. The non-transitory computer-readable storage medium of claim 16, wherein the element-wise layer operation is selected from the group comprising:
an activation function;
an element-wise arithmetic operation;
a dropout operation; and
a bias-addition operation.

18. The non-transitory computer-readable storage medium of claim 16, wherein the normalization layer operation is selected from the group comprising:
a batch normalization operation;
a layer normalization operation; and
an instance normalization operation.

19. The non-transitory computer-readable storage medium of claim 16, wherein the pooling layer operation is selected from the group comprising:
a max pooling operation;
a min pooling operation; and
an average pooling operation.

20. The non-transitory computer-readable storage medium of claim 12, wherein each of the first tile and the second tile includes:
metadata comprising shape information that indicates a length for a respective dimension of the associated tile; and
one or more cells for storing numeric values across one or more dimensions of the associated tile.

21. The non-transitory computer-readable storage medium of claim 12, wherein the sequence of neural network layer operations of the fused neural network layer operate one or more tiles in the shared memory of the GPU, without invoking additional read or write operations to a global-memory array in a global memory region of the GPU.

22. The non-transitory computer-readable storage medium of claim 12, wherein the sequence of neural network layer operations of the fused neural network layer is executed by the GPU using a single GPU kernel.

23. A graphics processing unit (GPU) for executing a fused neural network layer that implements a sequence of neural network layer operations, the GPU comprising:
a global memory;
a set of thread blocks coupled to the global memory; and
a shared memory coupled to a respective thread block in the set of thread blocks,
wherein the respective thread block is configured to:
load a first tile of a first input tensor of the fused neural network layer, from a first global-memory array allocated for the first input tensor in the global memory, into a first shared-memory array allocated for the first tile in the shared memory, wherein the first tile comprises a partition of the first input tensor of a first size and shape for processing the fused neural network layer during a first tile-processing iteration; and
wherein the processing core is configured to:
perform a first neural network layer operation of the sequence of neural network layer operations, the first neural network layer operation comprising:
reading a first value from a first cell of the first tile;
generating a second value using a computation from the first neural network layer operation that operates at least on the first value; and
updating a second cell of a second shared-memory array allocated for a second tile in the shared memory, to store the second value into the second tile, thereby storing intermediate values of the fused neural network layer into a portion of the shared memory instead of writing the intermediate values into a portion of the global memory; and
perform at least one additional neural network layer operation of the sequence of neural network layer operations, the at least one additional neural network layer operation comprising:
generating a third value using computations from the at least one additional neural network layer operation, which operate at least on the second value in the second tile;
updating a third cell of a third shared-memory array in the shared memory to store the third value; and
storing the third cell to an output tensor of the fused neural network layer in the global memory.

24. The GPU of claim 23, wherein the processing core is configured to perform a respective neural network layer operation of the fused neural network layer by calling a function that corresponds to the respective neural network layer operation, wherein the function takes at least the first tile or the second tile as function arguments.

25. The GPU of claim 23, wherein the processing core is configured to perform the first neural network layer operation by:
iterating a third tile across one or more portions of a second input tensor in the global memory, for a respective iteration of the first tile across the first input tensor, wherein during a respective iteration of the third tile, the processing core is further configured to:
load the third tile from a portion of the second input tensor that corresponds to the tile iteration of the third tile;
generate the second value by performing the first neural network layer operation, which requires two nested traversals of the first and second input tensors using the first tile and the third tile; and
update the second cell by accumulating the second value into the second cell using an operation selected from the group consisting of addition, maximum comparison, and minimum comparison.

26. The GPU of claim 23, wherein each of the first tile and the second tile includes:
metadata comprising shape information that indicates a length for a respective dimension of the associated tile; and
one or more cells for storing numeric values across one or more dimensions of the associated tile.

27. The GPU of claim 23, wherein the sequence of neural network layer operations of the fused neural network layer operate one or more tiles in the shared memory of the GPU, without invoking additional read or write operations to a global-memory array in a global memory region of the GPU.

28. The GPU of claim 23, wherein the sequence of neural network layer operations of the fused neural network layer is executed by the processing core using a single GPU kernel.
